(19) United States
(12) Patent Application Publication
(10) Pub. No.: US 2025/0124300 A1
(43) Pub. Date: Apr. 17, 2025

(54) TASK-AGNOSTIC CONTINUAL LEARNING OF SYSTEMS PERFORMANCE BY EFFICIENTLY MANAGING ENSEMBLE MEMORY

(71) Applicant: Dell Products L.P., Round Rock, TX (US)

(72) Inventors: Isabella Costa Maia, São Paulo (BR); Karen Stéfany Martins, Belo Horizonte (BR); Pablo Nascimento da Silva, Niterói (BR); Werner Spolidoro Freund, Rio de Janeiro (BR)

(21) Appl. No.: 18/485,637

(22) Filed: Oct. 12, 2023

(51) Int. Cl. G06N 3/096; G06N 3/045

(52) U.S. Cl. CPC G06N 3/096; G06N 3/045

(57) ABSTRACT

Techniques for enabling a task-agnostic continual learning (CL) system to handle an unlimited number of tasks and/or classes are disclosed. The weights of a pre-trained encoder are frozen. A memory pool of models/classifiers is accessed. The pre-trained encoder encodes an input. The encoded data is used to obtain a top-k nearest set of models from the memory pool. These models operate using the encoded data. Their output is decoded into a sparse matrix, which is then aggregated. The top-k nearest set of models are then updated based on the aggregation. In doing so, the CL system is now able to handle a new class or a new task.

### FIELD OF THE INVENTION

Embodiments of the present invention generally relate to updating a continual learning system. More particularly, at least some embodiments of the invention relate to systems, hardware, software, computer-readable media, and methods for implementing a task-agnostic continual learning (CL) system that is adapted to handle an unlimited number of tasks and/or classes.

### BACKGROUND

Continual Learning (CL) technology allows systems to learn several tasks sequentially, without forgetting previously seen tasks, and to take advantage of forward and backward transfer of knowledge between known patterns. CL assumes that data arrives in batches, and each collection of data is seen by the system only once. This allows many different tasks to be handled by the same deep neural network, reducing the necessity for storage of the model and training data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 illustrates an example CL system.

FIG. 2 illustrates various phases for updating a CL system.

FIG. 3 illustrates further aspects of the CL system.

FIG. 4 illustrates a metadata file.

FIG. 5 illustrates steps for training a classifier/model.

FIG. 6 illustrates steps for updating metadata.

FIG. 7 illustrates steps for updating models.

FIG. 8 illustrates a sparse matrix.

FIG. 9 illustrates steps in a prediction process.

FIG. 10 illustrates operations involving weights for a model according to its similarity with certain input.

FIG. 11 illustrates a method for improving a CL system.

FIG. 12 illustrates an example computer system capable of performing any of the disclosed operations.

### DETAILED DESCRIPTION OF SOME EXAMPLE EMBODIMENTS

CL, also known as “lifelong learning,” “sequential learning,” or “incremental learning” is a growing machine learning paradigm that aims to learn new tasks continuously and adaptively by adding knowledge to the model without sacrificing the previously acquired knowledge. Unlike traditional architectures that focus on solving a single task at a time, CL involves training a single model to perform many tasks using less computational power and less model storage. CL deals with the stability-plasticity dilemma, which focuses on accumulating knowledge (plasticity) without catastrophically forgetting prior knowledge (stability).

A single model capable of performing multiple tasks takes advantage of learned concepts such as forward and backward transfer. The previously acquired knowledge is used in new tasks, and the new task examples improve already learned ones, which avoid restarting the training process from zero and which lead to better generalization.

Generally, CL is divided into three scenarios: domain-incremental learning, task-incremental learning, and class-incremental learning. In domain-incremental learning, tasks have the same classes, but input distributions are different. In task-incremental learning, the model is informed about which task needs to be performed, thereby enabling models to have task-specific components. In class-incremental learning, models are able to solve each task seen so far and to infer which one they are presented with. All three scenarios assume that task boundaries are known during training. Such assumptions, however, can be a disadvantage when the task identity is not available. Task agnostic CL focuses on the scenario where the task boundaries are not known during training.

The disclosed embodiments are directed to task-agnostic CL, where data arrives sequentially and can contain a new class or task never seen before. During training, the embodiments have access only to the current data. One objective of the embodiments is to adapt the learning so as to handle an unlimited number of tasks and classes.

The disclosed embodiments provide significant improvements, advantages, benefits, and practical applications in the technical field of CL. Traditional techniques for performing task agnostic CL were limited in that the initial number of classes those techniques could handle were pre-defined in the system initialization. The disclosed embodiments, on the other hand, beneficially remove such a limitation. This limitation is removed by adding a memory and metadata handling mechanism that allows for the learning of an unlimited number of classes.

As another benefit, the disclosed embodiments are able to handle CL using ensembles and encoders by managing the model's memory pool and metadata. This management allows for improved utilization of memory for the ensemble pool. This management further increases the capacity of the system to learn a larger number of classes, and this increase is achieved without requiring a restart of the system.

Additional benefits include the ability to dynamically manage models inside the ensemble memory of a CL system. The embodiments also advantageously allow the system to learn an indefinite number of classes. Yet another benefit involves the ability to manage metadata for improved performance and memory utilization. Accordingly, these and numerous other benefits will now be described in more detail throughout the remaining sections of this disclosure.

### Example Architectures

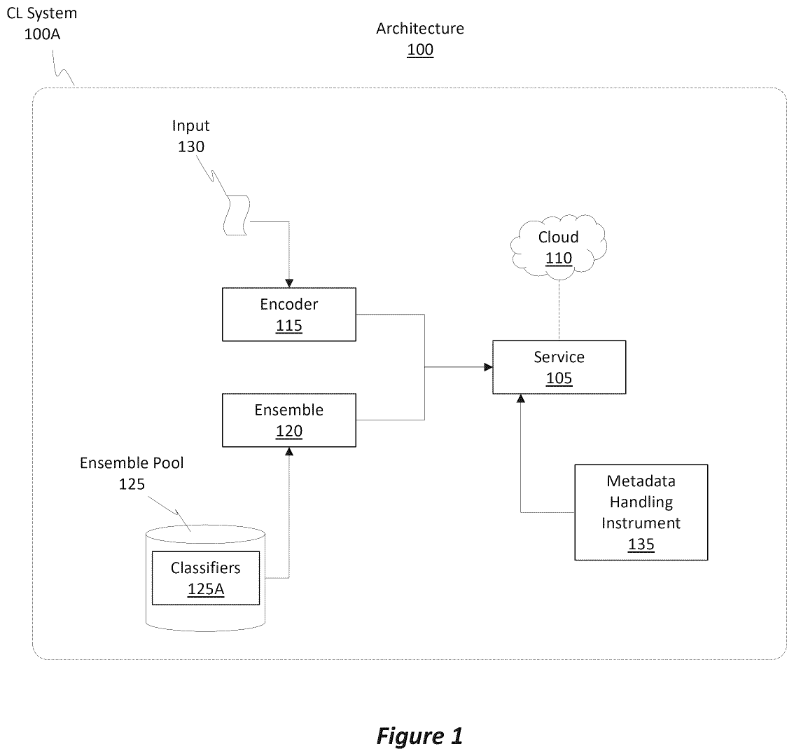

Attention will now be directed to FIG. 1, which illustrates an example architecture 100 that can be used to achieve the above benefits. Architecture 100 includes a CL system 100A, which is shown as including a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud environment 110. In some implementations, service 105 is a local service operating on a local device. In some implementations, service 105 is a hybrid service that includes a cloud component operating in the cloud and a local component operating on a local device. These two components can communicate with one another.

Service 105 is generally tasked with dealing with task-agnostic CL through an encoder 115 and an ensemble 120. Service 105 generally operates as follows.

Service 105 is able to consider a pre-trained encoder 115 that works as a feature extractor. Service 105 also considers an ensemble 120 associated with an ensemble pool 125 of single layer classifiers 125A (e.g., each model in the memory pool has a single layer topology or, alternatively, a multiple layer topology). Each classifier is associated with a random key generated from the latent space (called ensemble memory) of encoder 115.

Service 105 causes the encoder 115 to encode a given an input 130. Service 105 then uses the encoding result to search for similar classifiers 125A with the closest keys. This similarity analysis can, in some instances, be performed using a cosine similarity. Of course, other similarity operations can also be used. Service 105 then causes each similar classifier to use the same encoding as input. Finally, service 105 aggregates the results of the classifiers to generate a final output. If these were the only operations, then architecture 100 would be able to handle only a limited number of tasks and classes defined in the initialization. The disclosed embodiments, however, implement a solution to dynamically increase the number of learnable tasks and classes.

In particular, the embodiments are interested in solving the problem of predicting new classes and learning their patterns using a deep neural network system in order to solve different system prediction tasks. These are problems that may arise in several data-driven prediction systems, such as predicting reading response time, writing response time, and cache performance, among others. The CL approach has an advantage in that all of these tasks are handled by the same model and are capable of incorporating new predictive capabilities.

Hence, the embodiments build upon task-agnostic CL using the encoder 115 and the ensemble 120, as mentioned above. Historically, each model/classifier in the ensemble pool 125 was responsible for predicting a set of labels defined during initialization. Doing so prevented each model from learning more classes than a pre-defined size. Thus, this historical technique was limited to handle a limited number of tasks and classes as defined in the initialization of the system. The disclosed embodiments, on the other hand, present a mechanism to leverage architecture 100 by adding a metadata handling instrument 135 (and other tools) to allow service 105 to address an infinite number of tasks with an unlimited number of classes.

With the metadata handling instrument 135, the service 105 is now able to allow the ensembles to dynamically increase the number of learnable classes. Service 105 operates as follows.

First, an initialization process is performed. This initialization includes the service 105 obtaining a pre-trained encoder (e.g., encoder 115) to operate as a general feature extractor. The encoder 115 is pre-trained on tasks different than those tasks expected to be used in the training of the CL system 100A.

Service 105 freezes the weights of the encoder 115. This operation is performed to avoid catastrophic forgetting. Service 105 also builds a memory pool (e.g., ensemble pool 125) of M classifiers (e.g., classifiers 125A). Typically, these classifiers 125A are composed by simple single-layer topologies. Each classifier has a unique key h, which is the same size as the encoding.

Each classifier is initialized with the same initial output label set Y of size | Y|, defined by the classes contained in the first addressed task. Each classifier also has a related metadata file, which describes the task t and which maps the current labels set to the output of the model. For example, consider a model i that has an output head of size 10. This model may be capable of predicting classes [0 to 5, 8, 12 to 14]).

After the initialization process is complete, an inference (or prediction) process is performed. During this process, service 105 obtains the encoded representation x′ from an input x and a task identifier t.

Service 105 also obtains the top-k nearest classifiers in the model pool. These classifiers are obtained because they are related to the task t. This step is performed by applying a similarity score between the encoded representation and the ensemble keys (e.g., using a cosine similarity).

Service 105 uses the encoded representation as input to each one of the k models in the ensemble. Service 105 then causes the results of each model of the ensemble to be decoded in a sparse matrix. Notably, the number of columns in the matrix represents the total number of classes, and the number of lines or rows in the matrix is the ensemble size.

Service 105 aggregates the results according to the values of the similarity function for each model in the ensemble. Service 105 may also consider other characteristics of the problem presented in the metadata (e.g., probability of the model being selected).

After the inference phase, the embodiments update the model to handle new classes (i.e. a model update phase or process). In particular, whenever a new class or task arrives on the CL system 100A, service 105 triggers a re-training process or event. This re-training process is responsible for making the system/architecture 100 handle more classes or tasks.

If adding a new task t′, service 105 adds n new models to the ensemble 120 with its corresponding output size |Y_{new}|. A dataset D_{c} is given for every new class c in t′. Service 105 also obtains the encoded representation x′ of all instances in the dataset.

Service 105 updates all models in the ensemble pool closer to x′. To perform this update, service 105 adds a new class/task to the metadata and to the output of these models. This update is further performed by service 105 updating the selected models by backpropagating the errors. Additionally, service 105 can employ another CL method as Learning without Forgetting (LwF) or Elastic Weight Consolidation (EWC). Service 105 saves the required data in the metadata file. Service 105 then re-deploys the models.

In this manner, the disclosed embodiments are generally directed to a machine learning system that uses continual learning to adapt to different types of tasks during its execution. The system can be used in a variety of applications. As one example, consider a system for classification of the system's characteristics. Further consider a scenario involving the following three tasks with their respective target classes: (i) predicting response times of a storage system in intervals (t₀←Y₀ (low, medium, high)), (ii) predicting cache hit given workload characteristics (t₁←Y₁ (hit, miss), and (iii) predicting failures from a system (t₂←Y₂ (memory, cpu, motherboard)).

In the above scenario, it is desirable to build a unique model and to save memory and processing in building the model. These objectives can be achieved because the embodiments leverage the shared knowledge learned by all these tasks. One goal of the system is to build a machine learning model iteratively, so that the system first receives task one, then it receives task two. The embodiments adapt the model to work on both tasks, and so on. Alternatively, the embodiments may receive instances from both tasks at the same time and should be able to handle it.

### Further Details

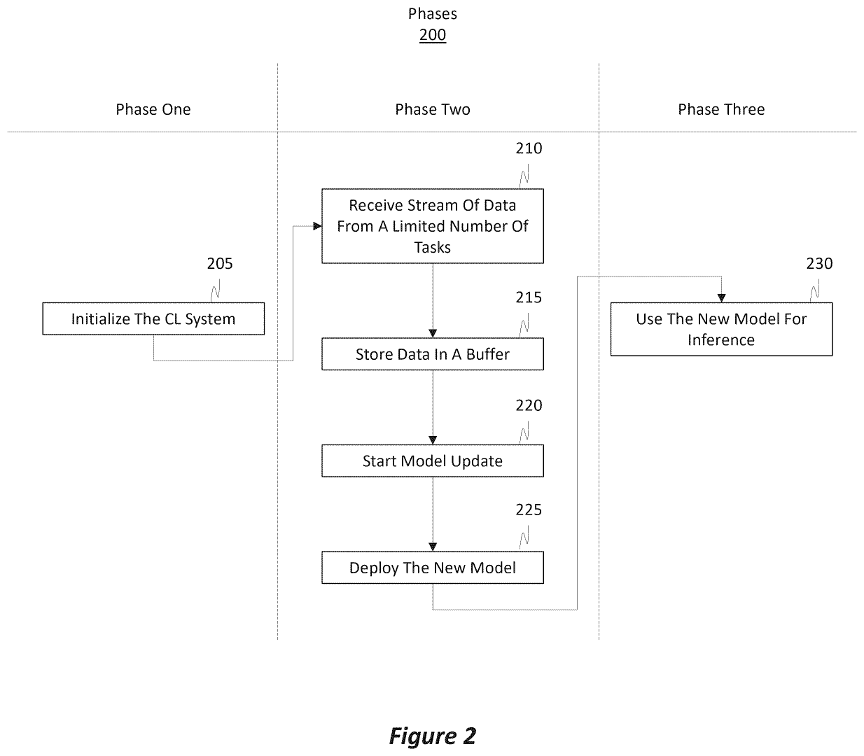

The disclosed embodiments leverage the encoders and ensembles for task-free CL (EECL) techniques described earlier to allow the embodiments to deal with an increasing number of tasks and classes. Beneficially, the embodiments incorporate the metadata handling instrument 135 into the architecture 100 (e.g., the CL system 100A) so that the embodiments can control and link the models in the ensemble pool to their correct task. FIG. 2 illustrates various phases 200 that may be implemented by service 105 of FIG. 1.

In particular, phase one includes an act 205 of initializing the CL system (e.g., CL system 100A) in a server. Phase two then includes an act (act 210) of receiving a stream of training data from a limited number of tasks. Act 215 includes storing the training data in a buffer. Act 220 includes starting the model update. This starting operation can be performed when the buffer is full or, alternatively, when a trigger is received. Act 225 includes deploying the new model. This new model is now ready to make predictions. Phase three (i.e. the prediction or inference phase) then includes an act (act 230) of using the new model for inferences.

In summary, phase one involves building the initial CL model through an encoders- and -ensembles architecture and involves initializing the metadata information. Phase two involves starting a mechanism to adapt the model to recognize new tasks and classes using CL, which avoids catastrophic forgetting of previous tasks. Phase three involves the inference (or prediction) of the system, which describes how the model applies an ensemble of classifiers together with the metadata to generate the final output. Further details on these phases will now be provided.

### Phase One-System Initialization

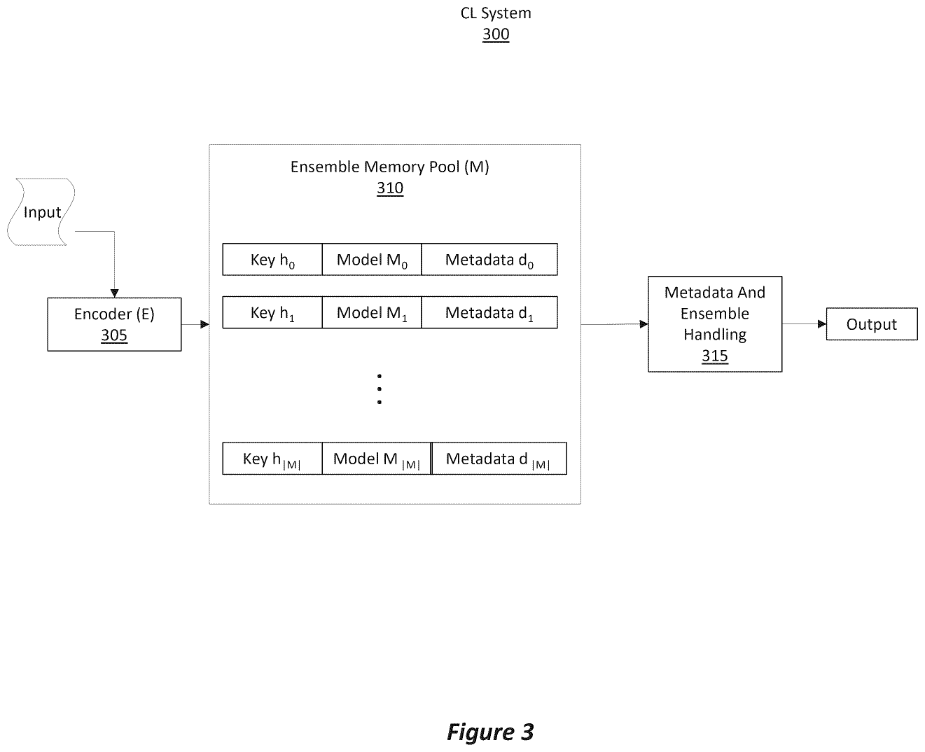

The first phase consists of initializing the CL system so that it can be prepared to learn a variety of new tasks. This step is responsible for defining the parameters of the CL system's initialization. The CL system includes three parts: (i) an encoder I (e.g., encoder 115) used to map a new input to the models stored in the memory; (ii) an ensemble memory pool (M) (e.g., ensemble pool 125), that includes a triplet of key, model, and metadata; and (iii) a metadata and ensemble handling module (which may be implemented by service 105) used to map the output of the models in the ensemble (e.g., ensemble 120) to their respective task outputs. FIG. 3 illustrates various aspects of the CL system.

FIG. 3 presents an overview of the main parts of the CL system 300. CL system 300 includes an encoder (E) 305, an ensemble memory pool (M) 310 of size |M|, where the pool includes triplets formed by key, model, and metadata. CL system 300 also includes metadata handling 315 used in the inference step.

The system initialization phase works as follows. First, the embodiments define the encoder model that will map the input to the keys inside the memory pool. Preferably, this is a model from a distinct task (i.e. a task that is not expected to be seen by the CL system). Also, to avoid catastrophic forgetting during downstream operations of the encoder, the encoder's weights are frozen.

Then, a specialist defines some parameters for the CL system. These parameters include (i) the encoder size that is going to be used to define the size of the key, (ii) the model architecture and its initialization, (iii) the number of outputs |Y| initially addressed by each model, (iv) the number of models in the ensemble |M|, (v) the number of new models added during training for every new re-training, (vi) the number k of selected models used for classification, and (vii) the structure of the metadata. Some additional configurations may also be passed to the CL system 300 in this first phase. For example, the information regarding training the models and additional methods for weight regularization may be obtained.

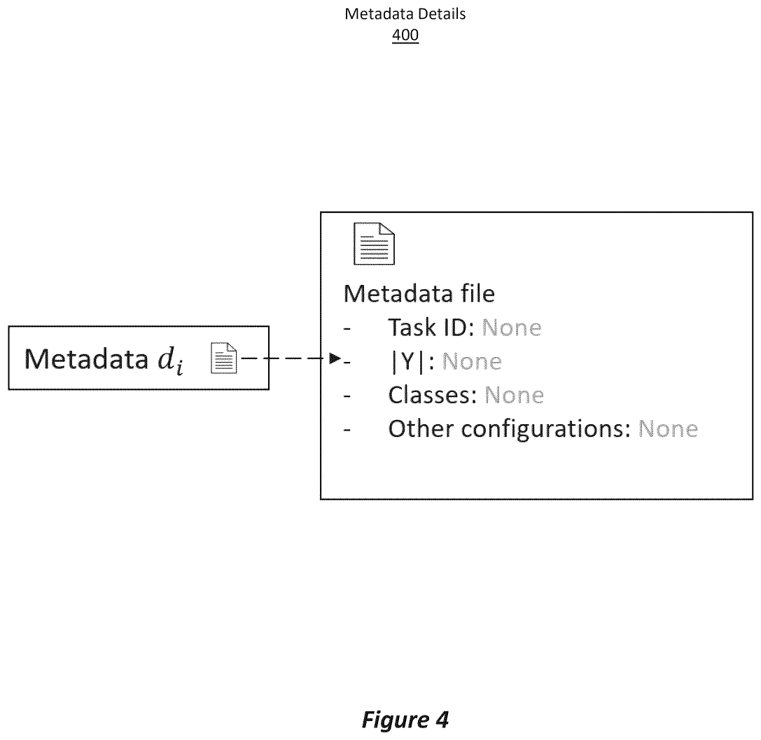

Once the parameters are defined, the embodiments initialize the memory pool with the pre-defined number of models. These models' parameters are randomly initialized (or initialized according with one or more parameters, as described previously). Also, in the memory pool, the system initializes the keys with random values of the encoding size and builds the sketch of the metadata file. The keys, model, and metadata triplets are then stored in the memory pool. FIG. 4 shows various metadata details 400. In particular, FIG. 4 shows an example of the initialized metadata file linked with a given model (e.g., Mᵢ).

### Phase Two-Model Update

Phase two involves adapting the model to a new task without forgetting previous tasks. In particular, in phase two, the embodiments approach how to update the model to handle new classes and tasks. The CL system receives a stream of datasets from a new task t (or from a limited range of tasks {t₀, t₁ ∈T}), with one of them being stored in a buffer until the buffer limit size is reached and starts or triggers the model update. A training trigger could also be defined and used to start the model update. When the buffer is full or when the training is triggered, the embodiments create a new dataset D_{c} comprising buffer data. The embodiments use the encoder model to encode all dataset instances D_{c}′.

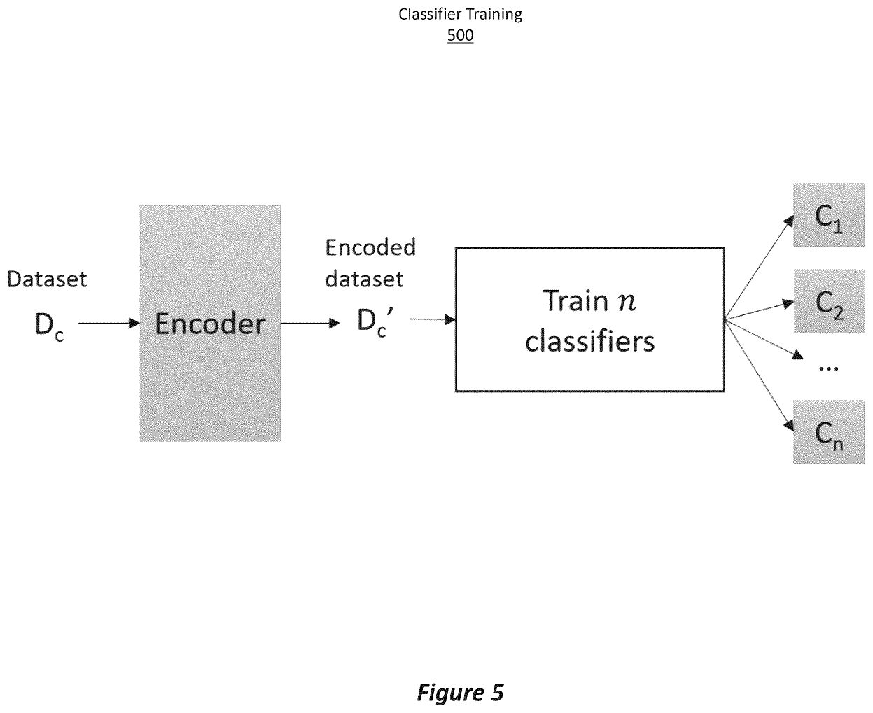

If dataset D_{c} is from a completely new task (or tasks), the embodiments train and add n new models to the ensemble pool for each task. All classifiers from the same task are initialized with the same initial output label set Y, of size |Y|, and the classifiers receive the encoded data as input. The above process is illustrated in FIG. 5, as shown by classifier training 500 operation.

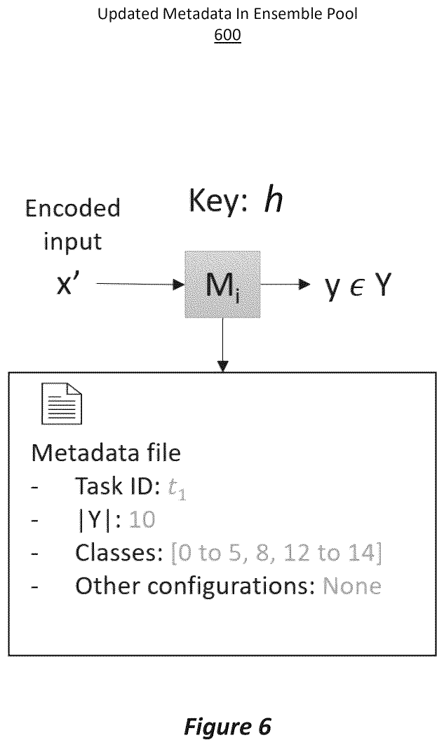

For each classifier, the CL system defines a random unique key h of the size of the encoding, and the CL system updates its metadata with the task identifier, number of classes |Y|, current labels set. As one example, consider a model i from task t₁ with an output head of size 10. This model may be capable of predicting classes [0 to 5, 8, 12 to 14]) and other configurations, if necessary. The keys, models, and metadata are stored in the memory pool. Then, the final model is re-deployed. FIG. 6 shows the updated metadata in the ensemble pool 600.

Otherwise, consider t′ at D_{c}′ has c new classes for task t. First, the embodiments select the top-k nearest classifiers. For example, the embodiments may calculate the cosine similarity between the models' keys in the ensemble pool and encodi'gs D_{c}′. For each model, the embodiments update its respective metadata file with the c new classes. To update the models and to avoid catastrophic forgetting, the embodiments may additionally employ another CL method, such as Learning without Forgetting (LwF) or Elastic Weight Consolidation (EWC). One advantage of updating just the top-k models is to save computational resources, especially training and storage costs. After training the models and updating the ensemble pool, the embodiments re-deploy the model.

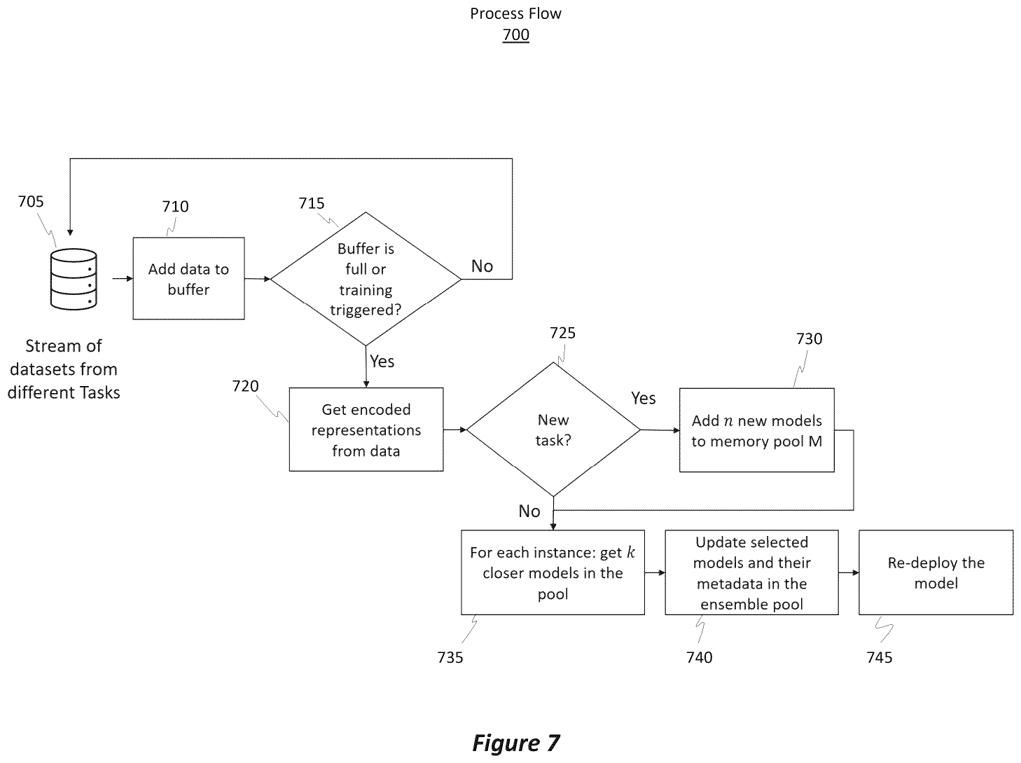

The complete process described in Phase two is represented in FIG. 7, as shown by process flow 700. Briefly, the embodiments obtain (act 705) a stream of datasets from different tasks. The embodiments add 710 data to the buffer. If the buffer is full or if training is triggered (act 715), then the embodiments obtain 720 encoded representations from the data. If not, then the process returns to act 705.

The embodiments determine whether a new task is available (act 725). If yes, then the embodiments add (act 730) n new models to the memory pool. If not, then the embodiments obtain (act 735) k closer models in the pool for each instance. Act 740 includes updating the selected models and their metadata in the ensemble pool. Act 745 includes re-deploying the model.

### Phase Three-Inference (or Prediction)

Phase three involves leveraging metadata information for handling tasks from different sizes. In particular, phase three is responsible for the inference action.

The inference is based on the selection of models from the memory pool and their aggregation using the metadata and ensemble handling part/instrument of the model. The inference operation acts as follows.

First, the embodiments apply the ensemble of classifiers trained in the earlier steps to predict new data. Given an input x and a task identifier t, the embodiments use the encoder to encode the input in x′.

Next, the embodiments filter models in the ensemble pool related to the task using the identifier t. To select the top-k nearest classifiers, the embodiments compare the similarity between the encoded input x′ and the model's keys using, for instance, a cosine similarity. Stated differently, the embodiments calculate the similarity between x′ and each model key from task t and select the k most similar keys. After selecting the most similar models, the embodiments use the encoded x′ as input to each selected model. Then, the embodiments create a sparse matrix with their results, where the columns represent the total number of classes and the lines or rows the total number of models.

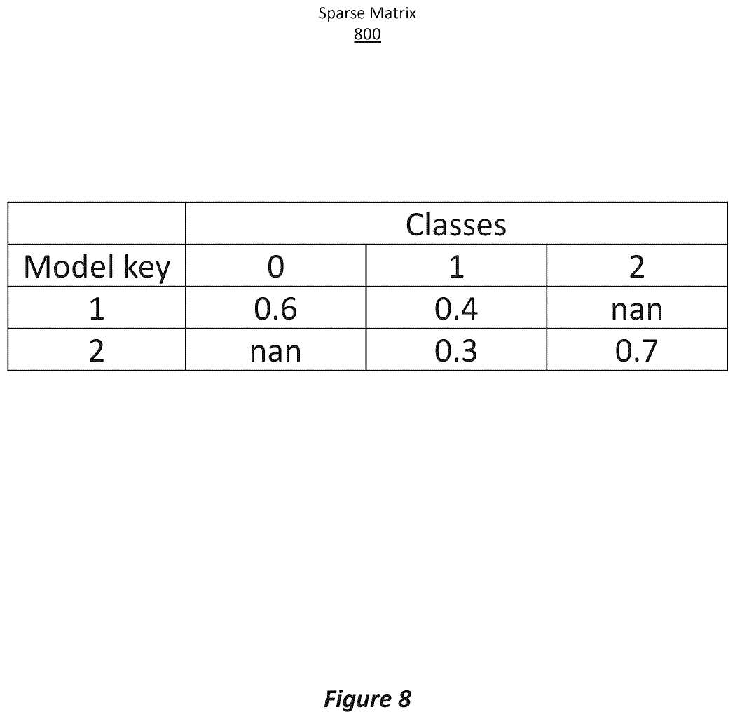

For instance, FIG. 8 illustrates a sparse matrix 800 from a task t where there are two models (1 and 2) and three classes (0, 1, and 2). “Nan” represents a class that the model is not able to predict. That is, the model was not trained using a dataset from that class. To illustrate, Model 1 and Model 2 did not learn classes 2 and 0, respectively. Notice, each model result (line) represents the probability for each class, and the summation of each line is 1.

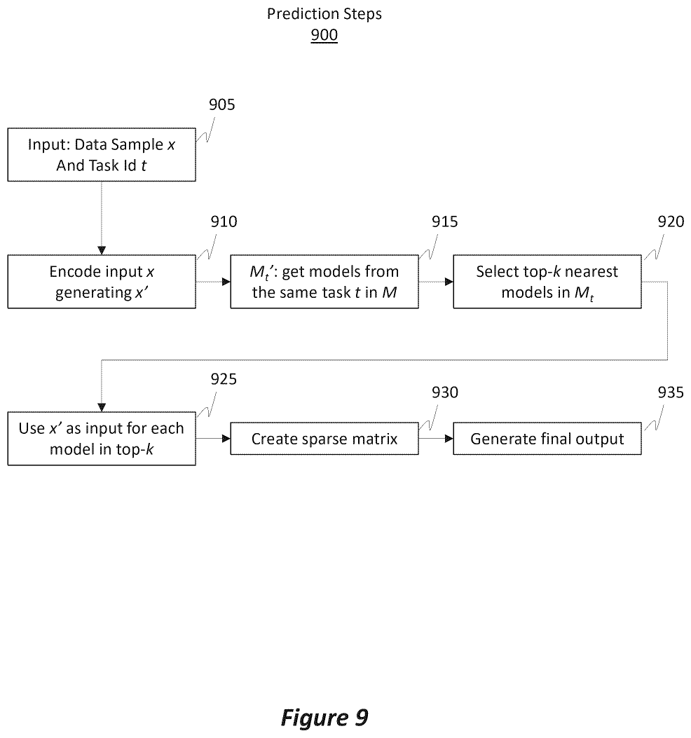

The embodiments then aggregate the sparce matrix to generate the final output. FIG. 9 illustrates the prediction steps 900 of an input sample x related to the task identify t. Prediction steps 900 include a step 905 of receiving input, comprising a data sample x and a task ID t. Step 910 includes encoding the input x to thereby generate x′. Step 915 includes obtaining models from the same task t in M, as shown by Mt′. Step 920 includes selecting the top-k nearest models in Mt. Step 925 includes using x′ as input for each mode in the top-k models. Step 930 includes creating the sparse matrix, and step 935 includes generating the final output.

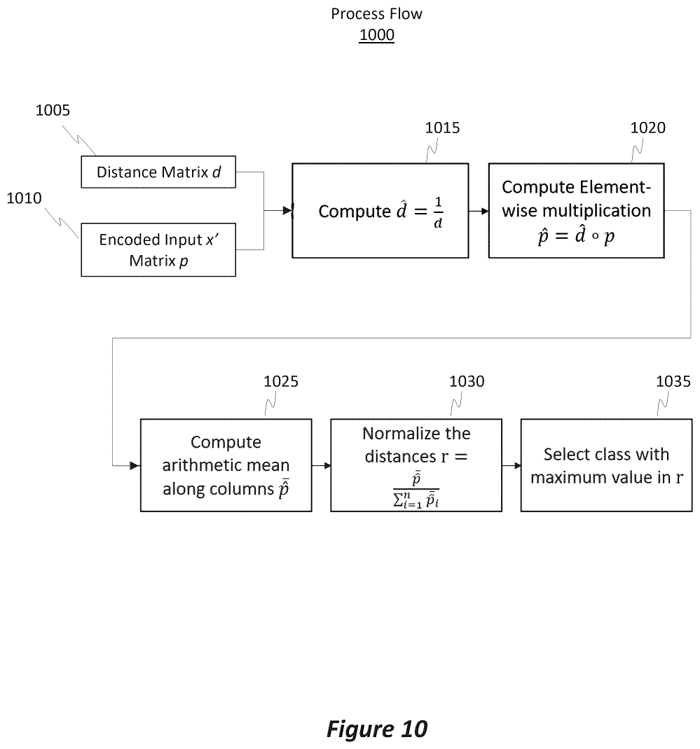

Different techniques are available to generate the final output from the sparse matrix. In one scenario, the embodiments considered a weight for each model according to its similarity with the input, which is represented in FIG. 10 by the process flow 1000. The algorithm receives one matrix d comprising the distances between each model key and the encoded input x′ (step 1005), and a sparse matrix p (step 1010). Then, to give more importance to nearby keys, the embodiments compute \hat{d} (step 1015). Next, the embodiments compute an element-wise multiplication between \hat{d} and p (step 1020), and the mean along columns of the result (step 1025). The embodiments normalize the distances (step 1030) and select the class with maximum values (step 1035).

As another example, consider a matrix d containing the distances between each model key and the encoded input x′, and the sparse matrix p of the last example.

$$d = [ \begin{matrix}1 \\ 1.5\end{matrix} ]$$

$$p = [ \begin{matrix}0.6 & 0.4 & nan \\ nan & 0.3 & 0.7\end{matrix} ]$$

Since the distance is a dissimilarity metric and it is desirable to give more importance to nearby keys, the embodiments compute \hat{d}:

$$\hat{d} = \frac{1}{d} = [ \begin{matrix}1 \\ 0.667\end{matrix} ]$$

Next, the embodiments apply an element-wise multiplication between p and \hat{d}:

$$\hat{p} = \hat{d} ∘ p = [ \begin{matrix}0.6 & 0.4 & nan \\ nan & 0.2 & 0.46666667\end{matrix} ]$$

Then, the embodiments compute the arithmetic mean along the columns of matrix \hat{p}, ignoring the nan values:

\hat{p̅}=[0.6 0.3 0.46666667]

To normalize the distances, the embodiments compute v, which is the sum of \hat{p̅}, and r as follows:

$$v = {\sum }_{i = 1}^{n} {\overline{\hat{p}}}_{i} = 1.0000000000000002$$

$$r = \frac{\overline{\hat{p}}}{v} = [ \begin{matrix}0.43902439 & 0.2195122 & 0.34146341\end{matrix} ]$$

Finally, the final output is the class with maximum value in r, which represents class 0 in this example.
r=[0.43902439 0.2195122 0.34146341]

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

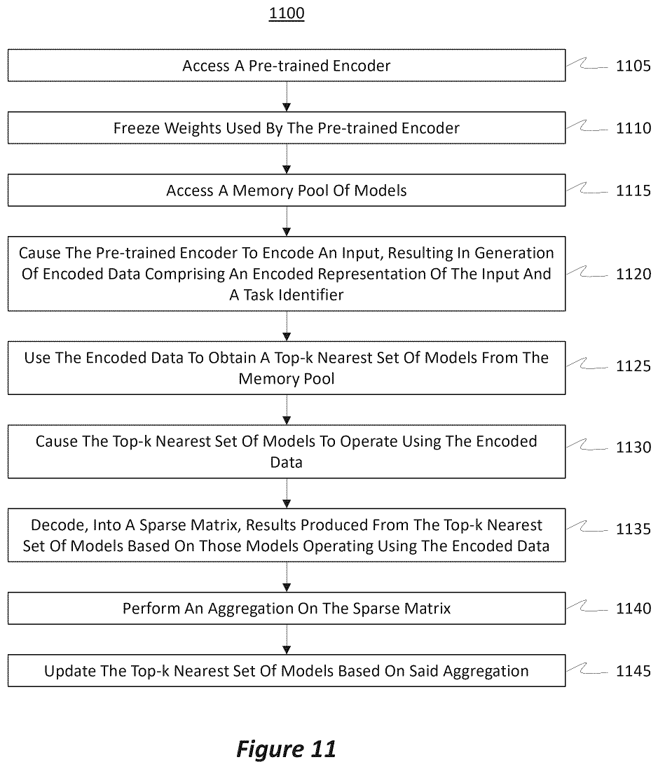

Attention will now be directed to FIG. 11, which illustrates a flowchart of an example method 1100 for implementing a task-agnostic continual learning (CL) system (e.g., CLY system 100A of FIG. 1) that is adapted to handle an unlimited number of tasks and/or classes. Method 1100 can be implemented by service 105 of FIG. 1.

Method 1100 includes an act (act 1105) of accessing a pre-trained encoder. In some embodiments, the pre-trained encoder is pre-trained on tasks different than tasks used during training of the CL system. The pre-trained encoder can also operate as a feature extractor.

Act 1110 includes freezing weights used by the pre-trained encoder. The process of freezing the weights used by the pre-trained encoder prevents the CL system from forgetting previous training.

Act 1115 includes accessing a memory pool of models (aka classifiers). Each model in the memory pool is associated with a corresponding metadata file. Each corresponding metadata file describes the task and maps a current set of labels to the results of the top-k nearest set of models. Each model in the memory pool has a corresponding unique key. Each corresponding unique key has a size that is the same size as a size of the encoded representation of the input.

Act 1120 includes causing the pre-trained encoder to encode an input, resulting in generation of encoded data comprising an encoded representation of the input and a task identifier.

Act 1125 includes using the encoded data to obtain a top-k nearest set of models from the memory pool. The models in the top-k nearest set are determined to be related to a task identified by the task identifier. The process of obtaining the top-k nearest models may be based on a cosine similarity. In some implementations, using the encoded data to obtain the top-k nearest set of models from the memory pool includes applying a similarity score between the encoded representation of the input and a set of ensemble keys.

Act 1130 includes causing the top-k nearest set of models to operate using the encoded data.

Act 1135 includes decoding, into a sparse matrix, results produced from the top-k nearest set of models based on those models operating using the encoded data. The number of columns in the sparse matrix represents a total number of classes, and the number of lines or rows in the sparse matrix represents a size of an ensemble.

Act 1140 includes performing an aggregation on the sparse matrix. For instance, the data in columns can be aggregated.

Act 1145 includes updating the top-k nearest set of models based on the aggregation. This updating enables the CL system to handle a new class or a new task. In some implementations, only those top-k models are updated.

### Example Computer Systems

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

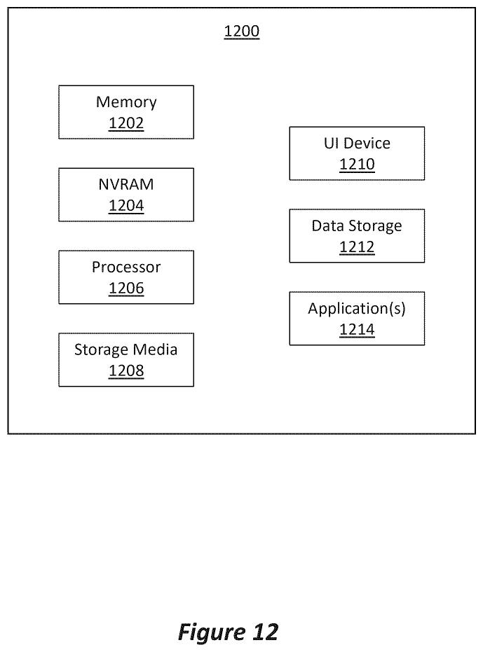

With reference briefly now to FIG. 12, any one or more of the entities disclosed, or implied, by the Figures and/or elsewhere herein, may take the form of, or include, or be implemented on, or hosted by, a physical computing device, one example of which is denoted at 1200. Also, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory 1202 of the physical computing device 1200 may take the form of solid-state device (SSD) storage. As well, one or more applications 1214 may be provided that comprise instructions executable by one or more hardware processors 1206 to perform any of the operations, or portions thereof, disclosed herein. Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The physical device 1200 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for implementing a task-agnostic continual learning (CL) system that is adapted to handle an unlimited number of tasks and/or classes, said method comprising:
accessing a pre-trained encoder;
freezing weights used by the pre-trained encoder;
accessing a memory pool of models, wherein each model in the memory pool is associated with a corresponding metadata file;
causing the pre-trained encoder to encode an input, resulting in generation of encoded data comprising an encoded representation of the input and a task identifier;
using the encoded data to obtain a top-k nearest set of models from the memory pool, wherein the models in the top-k nearest set are determined to be related to a task identified by the task identifier;
causing the top-k nearest set of models to operate using the encoded data;
decoding, into a sparse matrix, results produced from the top-k nearest set of models based on those models operating using the encoded data;
performing an aggregation on the sparse matrix; and
updating the top-k nearest set of models based on said aggregation, wherein said updating enables the CL system to handle a new class or a new task.

2. The method of claim 1, wherein obtaining the top-k nearest models is based on a similarity score.

3. The method of claim 1, wherein the pre-trained encoder is pre-trained on tasks different than tasks used during training of the CL system.

4. The method of claim 1, wherein freezing the weights used by the pre-trained encoder prevents the CL system from forgetting previous training.

5. The method of claim 1, wherein each corresponding metadata file describes the task and maps a current set of labels to the results of the top-k nearest set of models.

6. The method of claim 1, wherein using the encoded data to obtain the top-k nearest set of models from the memory pool includes applying a similarity score between the encoded representation of the input and a set of ensemble keys.

7. The method of claim 1, wherein a number of columns in the sparse matrix represents a total number of classes.

8. The method of claim 7, wherein a number of rows in the sparse matrix represents a size of an ensemble.

9. The method of claim 1, wherein the pre-trained encoder operates as a feature extractor.

10. A computer system that implements a task-agnostic continual learning (CL) system that is adapted to handle an unlimited number of tasks and/or classes, said computer system comprising:
one or more processors; and
one or more hardware storage devices that store instructions that are executable by the one or more processors to cause the computer system to:
access a pre-trained encoder;
freeze weights used by the pre-trained encoder;
access a memory pool of models, wherein each model in the memory pool is associated with a corresponding metadata file;
cause the pre-trained encoder to encode an input, resulting in generation of encoded data comprising an encoded representation of the input and a task identifier;
use the encoded data to obtain a top-k nearest set of models from the memory pool, wherein the models in the top-k nearest set are determined to be related to a task identified by the task identifier;
cause the top-k nearest set of models to operate using the encoded data;
decode, into a sparse matrix, results produced from the top-k nearest set of models based on those models operating using the encoded data;
perform an aggregation on the sparse matrix; and
update the top-k nearest set of models based on said aggregation, wherein said updating enables the CL system to handle a new class or a new task.

11. The computer system of claim 10, wherein each model in the memory pool has a corresponding unique key.

12. The computer system of claim 11, wherein each corresponding unique key has a size that is the same size as a size of the encoded representation of the input.

13. The computer system of claim 10, wherein each model in the memory pool is initialized with a same initial output label set of a particular size, defined by classes contained in the task.

14. The computer system of claim 10, wherein each model in the memory pool has a single layer topology or, alternatively, a multiple layer topology.

15. The computer system of claim 10, wherein a re-training event is triggered in response to the new class arriving.

16. The computer system of claim 10, wherein a re-training event is triggered in response to the new task arriving.

17. The computer system of claim 10, wherein, when the new task is added, one or more new models are added to the memory pool.

18. A method for implementing a task-agnostic continual learning (CL) system that is adapted to handle an unlimited number of tasks and/or classes, said method comprising:
accessing a pre-trained encoder that operates as a feature extractor;
accessing a memory pool of classifiers, wherein each classifier in the memory pool is associated with a corresponding metadata file;
causing the pre-trained encoder to encode an input, resulting in generation of encoded data comprising an encoded representation of the input and a task identifier;
using the encoded data to obtain a top-k nearest set of classifiers from the memory pool, wherein the classifiers in the top-k nearest set are determined to be related to a task identified by the task identifier;
causing the top-k nearest set of classifiers to operate using the encoded data;
decoding, into a sparse matrix, results produced from the top-k nearest set of classifiers based on those classifiers operating using the encoded data;
performing an aggregation on the sparse matrix; and
updating the top-k nearest set of classifiers based on said aggregation, wherein said updating enables the CL system to handle a new class or a new task.

19. The method of claim 18, wherein the method further includes filtering the classifiers in the memory pool to identify classifiers related to the task.

20. The method of claim 18, wherein only the top-k nearest set of classifiers are updated.
